(19) United States
(12) Patent Application Publication
(10) Pub. No.: US 2008/0184318 A1
(43) Pub. Date: Jul. 31, 2008

(54) System and method for acquiring broadcast program content

(76) Inventor: Nigel Horbury, Banner Elk, NC (US)

Correspondence Address: JAMES RAY & ASSOCIATES, 2640 PITCAIRN ROAD, MONROEVILLE, PA, 15146, US

(21) Appl. No.: 11/700,293

(22) Filed: Jan. 31, 2007

(51) Int. Cl. H04N 7/173

(52) U.S. Cl. 725/87

(57) ABSTRACT

The present invention provides a system and method for acquiring broadcast program content transmitted by a satellite network and received at a device capable of providing an audio or video output in response to receiving the satellite transmission. The user issues the request while the desired program content is being output and the program content reference data and the user reference data are being transmitted through a satellite network or through an independent data transmission network. The substantially identical copy of the requested program content is delivered to the user by way of the download or by way of the data storage device.

### FIELD OF THE INVENTION

The present invention relates, in general, to communication systems and, more particularly, this invention relates to a system and method for acquiring broadcast program content and, yet more particularly, the instant invention relates to a system and method for acquiring program content which is broadcast over a satellite network.

### BACKGROUND OF THE INVENTION

One difficulty that is continuously experienced by those who listen to radio broadcasts during driving is in being able to make a record of a particular broadcast content in order to acquire a copy of such broadcast content at a later date.

Since it is unsafe to write down information during driving and writing implements may not be readily available during the broadcast, the listener is forced to look for a safe and convenient opportunity to temporarily park the car and write down pertinent information associated with such broadcast content or to memorize such pertinent information for a period of time. The person must then spend additional effort in acquiring the copy of the program content either by visiting the retail establishment or by ordering the program content over the phone or Internet. A similar difficulty is experienced by listeners of the broadcast content over a radio or a television network in a home, work or commercial environment.

Lately, wireless devices which are capable of receiving broadcast music and data content over a satellite network and providing a responsive audio or video output have been gaining wide acceptance, particularly, for use in vehicles. Currently, these networks are being operated by Sirius Satellite Radio, Inc. and by XM Satellite Radio Holdings, Inc. Such devices expose the listener to a greater content as compared with conventional radio or television broadcasts.

Prior to the present invention, efforts have been made to alleviate the difficulties of acquiring the copy of the selected broadcast content. For example, U.S. Pat. No. 7,010,263 issued to Patsiokas discloses a system and method for distributing music and data. The music or data is first transmitted to a consumer via a satellite radio network.

The system includes a satellite radio receiver for the user which is capable of receiving the wireless transmission and providing an audio and/or visual output in response thereto. In addition, the receiver is adapted to receive an input (e.g., voice command) from the user by which the user is able to signal an interest in recording a selection of music or data being played and/or displayed.

In response to this signal and a record-ability signal, an ID signal is stored on a removable media which identifies the selection being played and/or displayed. The ID signal may be a composite signal indicating the time and channel, a signal that identifies a selection by number, or other suitable ID signal. Finally, the system includes a computer for allowing the user to use the removable media to retrieve the desired selection via the second network such as private distribution hub or the World Wide Web.

In the specific illustrative embodiment, the removable media is electronic (flash) memory. The web site is implemented with software running on a server which translates the ID signal into a human readable identification (e.g., title and artist) of the music or data selected. The user then either downloads the desired selection through the web site or places an order for delivery of physical media (e.g., a CD) on which the desired selection is stored. However, such prior art system still requires greater than desirable effort to order a copy of the distributed program content.

### SUMMARY OF THE INVENTION

According to one embodiment, the invention provides a method of acquiring broadcast program content. The method include the step of transmitting by a first means the program content and a first reference data characterizing the program content to a user. Then, receiving by the user the transmitted program content and the first reference data. Next, requesting by the user the received program content. Receiving at one of the first means and a second means the first reference data characterizing the at least a portion of the requested program content. Next, receiving at one of the first means and the second means a second reference data characterizing the user when the program content is requested by the user. Finally, delivering to the user by way of the one of the first means and the second means a substantially identical copy of the requested program content.

According to another embodiment of the invention, there is provided a system for acquiring broadcast program content. The system includes a first means for transmitting the program content and a first reference data characterizing the program content to a user. A second means is provided for receiving the program content and the first reference data and for outputting the program content in at least one of a video and audio fashion. A third means is provided for receiving user input while the program content is being received and output by the second means. There is a forth means for delivering a substantially identical copy of the program content to the user in response to receiving the user input.

### OBJECTS OF THE INVENTION

It is, therefore, one of the primary objects of the present invention to provide a system and method for acquiring broadcast program content.

Another object of the present invention is to provide a system and method for acquiring broadcast program content over a wireless or cable based network.

Yet another object of the present invention is to provide a system and method for acquiring broadcast content which allows a person to request such program content without writing or memorizing pertinent content information.

A further object of the present invention is to provide a system and method for acquiring broadcast program content which provides a person who requests such program content with different delivery options.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a block diagram of a system for acquiring broadcast program content of the present invention;

FIG. 2 is a block diagram of a device employed within the system of FIG. 1 for at least receiving the broadcast program content;

FIG. 3 is a block diagram of the system of FIG. 1, showing employment of independent means for requesting the copy of the broadcast content; and

FIG. 4 is a block diagram of the system for acquiring broadcast program content of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

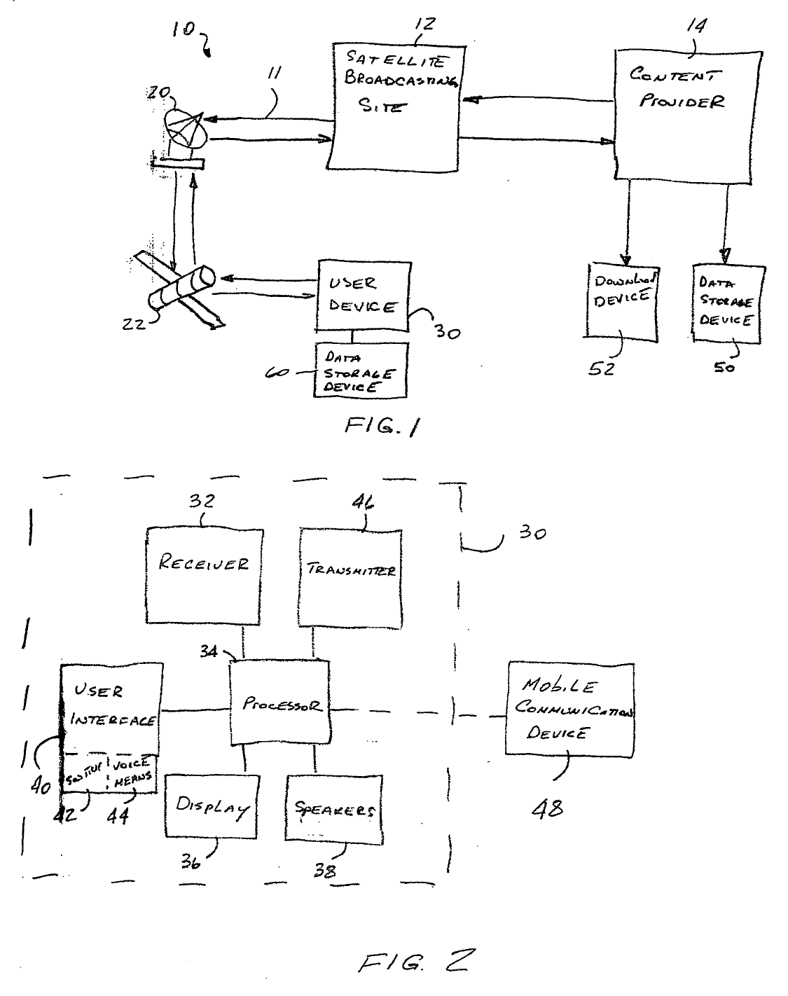

The present invention provides a method of acquiring broadcast program content using the system, generally designated as 10, of the present invention. The method includes the step of transmitting the program content to a user. Now in reference to FIGS. 1-2, the program content, such as audio, video or data in a digital format, is transmitted by a first network 11 which employs a broadcasting site 12 capable of transmitting information through an antenna means 20 and through at least one satellite 22 generally owned by such broadcasting site 12.

Such program content is received by the user at a device 30 which includes a receiver means 32, a processor means 34 and an output means capable of providing at least one of video and audio output, by way of display 36 and speakers 38, respectively, in response to the transmission. The above devices and the method of transmitting, receiving and outputting program content are disclosed for example in U.S. Pat. No. 7,010,263 issued to Patsiokas, the teachings of which are incorporated into this document by reference thereto.

The program content may be owned by such broadcasting site 12 or may be owned by a content provider 14 such as a radio station, recording studio, film studio, production studio, commercial establishment licensed to distribute program content and the like. When the program content is owned by the content provider 14, the broadcasting site 12 is simply employed as a distribution means of such program content to a wide variety of users each having the device 30 and being generally bound by a contract agreement with such broadcasting site 12 to receive the program content.

The system 10 further includes a user interface 40 which is connected to the device 30 and is usable by the user to request the program content being received at the device 30. The user interface 40 may include a simple switch means 42, a voice recognition means 44 or other suitable means as disclosed in U.S. Pat. No. 7,010,263.

When the user requests the program content being received at the device 30, the identification code which characterizes such program content and which is sent therewith, generally as a header, is transmitted back to the broadcasting site 12 by the transmitter means 46 provided within the device 30. Simultaneously, reference information which characterizes the user of the device 30 and which is generally stored there within is also transmitted to the broadcasting site 12.

In response to providing both identification code and the user reference information, the user receives a substantially identical copy of such selection. The present invention contemplates that the user may request only a portion of the program content. By way of an example, such portion may represent a single song from the album being broadcast or a plurality of songs from the album. In either instance, the appropriate and respective identification code or codes will be transmitted.

According to one embodiment of the invention, the copy of the selection requested by the user may be delivered by way of a data storage device 50 which may be one of a compact disk, digital video disk and flash memory means. Such flash memory means includes but is not limited to a memory card, PC card, multimedia card, memory stick and flash card. The appearance of the data storage device 50 may be customized to meet specific user preferences.

According to another embodiment of the invention, the copy of the program content requested by the user may be delivered electronically by way of a download to a download device 52 specified by the user which includes but is not limited to a computer, music player, video player, and mobile communication device such as mobile phone or Personal Digital Assistant (PDA).

According to yet another embodiment of the invention, the user request containing the identification code and the user reference information may be temporarily stored at a predetermined location, for example, the content provider 14, in order to enable the user to download the copy of the program content by way of Internet and further in combination with an electronic device such as an iPod manufactured by Apple Corp. or its equivalent, MP3 player, computer and the like.

Such copy of the program content may be delivered to the user immediately after the request has been received at the broadcasting site 12 or at the content provider 14. It is within the scope of the present invention that the copy of the program content is received by the user from the broadcasting site 12 or from the content provider 14 according to predetermined conditions. For example, the program content may be delivered to the address specified by the user by way of the data storage device 50 when such device 50 is completely filled with various selections requested by the user or at a predetermined duration of time specified by the user.

The invention contemplates that the user may request such program content by means which is independent from the device 30 and the broadcasting site 12.

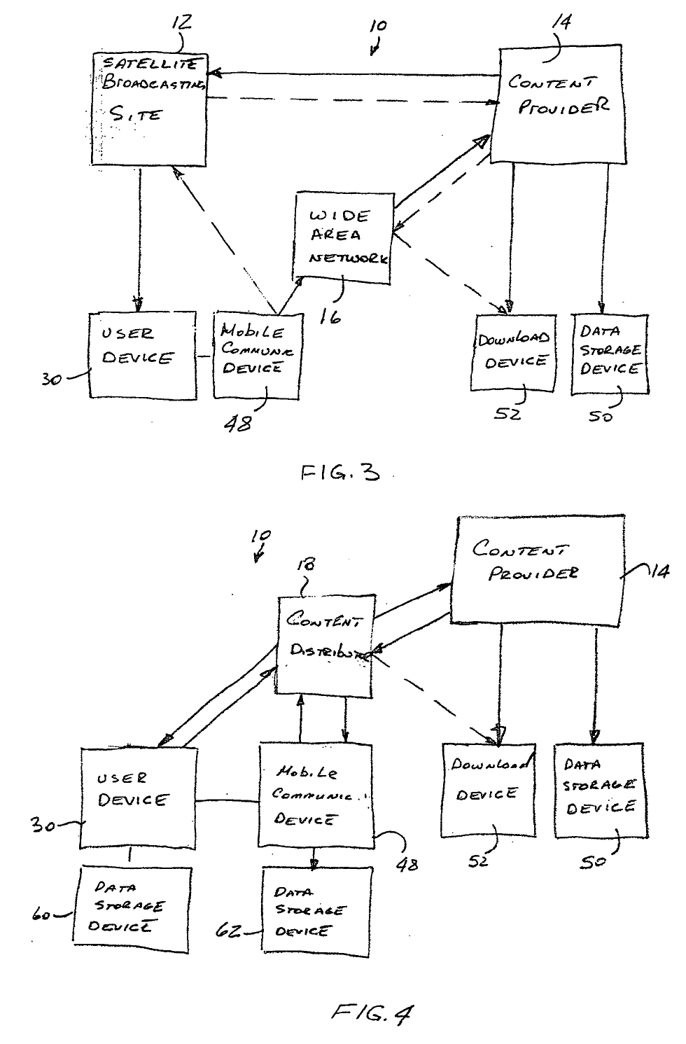

Now in reference to FIGS. 2-3, for example, the user may issue the request by way of a mobile communication device 48 which is connected to a Wide Area Network (WAN) 16, which may include a mobile phone network constructed according to presently employed third-generation (3G) and forth-generation (4G) technologies as well as next-generation technologies, an independent satellite communication system, a cable network or various combinations thereof. Mobile communication device 48 includes but is not limited to mobile phone, Personal Digital Assistant (PDA), Global Positioning System (GPS) device, on-board vehicle communication unit, TV set, computer and the like.

By way of an example only, the user of a mobile phone 48 may dial a predetermined number and enter the identification code of the selected program content. It is further within the scope of the present invention that the mobile communication device 48 is coupled to the device 30, as best shown in FIG. 2. Accordingly, the selection content is transmitted by the mobile communication device 48 without additional effort and interface from the user. It will be apparent to those skilled in the art that capability of the mobile communication device 48 may be integrated within the device 30.

When the user chooses to receive the selected program content at a predetermined duration of time after the request, the broadcasting site 12 or the content provider 14 may communicate, for example by way of Internet, to remind the user about stored requests and may send a short excerpt from each requested selection in order to enable the user to make a final decision. The user may then decline or erase at least one selection, confirm the intent to purchase a single selection or a grouping of requested selections and purchase additional selections.

It is further within the scope of the present invention that the program content may be requested by way of the device 30 which is connected to at least one of a wireless cellular telephone network, Internet network or cable network. Accordingly, the broadcasting site 12 will be replaced by the content distributor 18, for example, a cable network operator, as best shown in FIG. 4.

It will be understood, that the user will benefit from acquiring at least the portion of the distributed program content without writing or memorizing pertinent content information. Thus, the user will not have to interrupt other activities performed during the broadcast which is advantageous while driving. The user is also not required to expend additional effort by using Internet or other means to order the predetermined program content.

Additional benefit is realized by the content provider 14 in the form of generated revenues and potential reduction in advertising and marketing expenses associated with offering prepackaged program content through retail establishments. The content provider will also realize improved control of legally distributing program content to members of the general public.

Although the present invention has been shown in terms of the data storage device being delivered by the content provider of a content distributor, it will be apparent to those skilled in the art, that the program content may be recorded onto a data storage device 60 while it is removably received within the device 30 or by way of a data storage device 62 which is removably received within the mobile communication device 48, particularly considering that the cost of these data storage devices has been decreasing while their capacity has been increasing. Therefore, the user will simply remove the data storage device 60, 62 when it is filled with the requested content and insert a new data storage device 60, 62 for acquiring additional program content.

It will be apparent to those skilled in the art, that the device 30 of FIG. 2 may be easily reconfigured to receive program content and its reference identification data by way of cable, wireless cellular telephone or Internet network as well as transmit user request therethrough.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A method of acquiring broadcast program content, said method comprising the steps of:
(a) transmitting by a first means said program content and a first reference data characterizing said program content to a user;
(b) receiving by said user said program content and said first reference data transmitted in step (a);
(c) requesting by said user said program content being received in step (b);
(d) receiving at one of said first means and a second means said first reference data characterizing said program content requested by said user in step (c);
(e) receiving at said one of said first means and said second means a second reference data characterizing said user when said program content is requested in step (c); and
(f) delivering to said user by way of said one of said first means and said second means a substantially identical copy of said program content requested by said user in step (c).

2. The method, according to claim 1, wherein said method includes receiving reference data by at least one of a satellite transmission means, a wide area network, an Internet based network and a cable based network means.

3. The method, according to claim 1, wherein said method includes receiving said program content as an at least one of an audio and a video transmission.

4. The method, according to claim 1, wherein said method includes the step of receiving said program content by said user at a device capable of playing said program content in at least one of an audio and a visual fashion.

5. The method, according to claim 1, wherein said method includes the step of requesting said program content by said user by way of a device capable of playing said program content in at least one of an audio and a visual fashion.

6. The method, according to claim 1, wherein said method further includes the step of storing a request by said user within said one of said first means and said second means for a predetermined period of time prior to delivering said copy of said program content in step (f).

7. The method, according to claim 6, wherein said method further includes the step of reminding said user about requested program content prior to delivering said copy of said at least a portion of said program content in step (f).

8. The method, according to claim 1, wherein said method includes the step of delivering a copy of said program content requested by said user in step (c) to said user in step (f) by way of a data storage device.

9. The method, according to claim 8, wherein said method includes the step of using a data storage device selected from one of a compact disk, digital video disk and flash memory means.

10. The method, according to claim 9, wherein said method includes the step of using a flash memory means selected from one of a memory card, PC card, multimedia card, memory stick and flash card.

11. The method, according to claim 1, wherein said method includes delivering said copy of said program content requested by said user in step (c) to said user in step (f) by way of a download using Internet transmission means.

12. A system for acquiring broadcast program content, said system comprising:
(a) a first means for transmitting said program content and a first reference data characterizing said program content to a user;
(b) a second means for receiving said program content and said first reference data and for outputting said program content in at least one of a video and audio fashion;
(c) a third means for receiving a user input while said program content is being received and being output by said second means; and
(d) a fourth means for delivering a substantially identical copy of said program content to said user in response to receiving said user input.

13. The system, according to claim 12, wherein each of said first means and said second means is one of a satellite transmission network, a wide area network, an Internet based network and a cable based network.

14. The system, according to claim 12, wherein said third means is capable of transmitting said user input to said fourth means independently from said first means.

15. The system, according to claim 12, wherein said third means is disposed integral with said second means.

16. The system, according to claim 12, wherein said third means is coupled to said second means and is capable of transmitting said first reference data and a second reference data characterizing said user.

17. The system, according to claim 12, wherein said substantially identical copy of said program content is delivered to at least one of said second means and said third means and whereby each of said second means and said third means is capable of storing said substantially identical copy of said program content.

18. The system, according to claim 12, wherein said substantially identical copy of said program content is stored on a removable data storage device.
